(19) United States
(12) Patent Application Publication
(10) Pub. No.: US 2026/0180444 A1
(43) Pub. Date: Jun. 25, 2026

(54) POWER CONVERTER HAVING TRANSIENT RESPONSE IMPROVEMENT MECHANISM

(71) Applicant: ANPEC ELECTRONICS CORPORATION, HSINCHU (TW)

(72) Inventor: FU-CHUAN CHEN, Hsinchu City (TW)

(21) Appl. No.: 19/048,987

(22) Filed: Feb. 10, 2025

(30) Foreign Application Priority Data
Dec. 19, 2024 (TW) 113149513

(51) Int. Cl. H02M 3/158; H02M 1/00; H02M 3/157

(52) U.S. Cl. CPC H02M 3/158; H02M 1/0016; H02M 3/157

(57) ABSTRACT

A power converter having a transient response improvement mechanism includes a first high-side switch, a first low-side switch, a second high-side switch, a second low-side switch and a control circuit. When an output voltage of a first terminal of the second high-side switch is lower than a lower limit threshold voltage, the control turns on the first high-side switch and the second low-side switch, and turns off the first low-side switch and the second high-side switch. Conversely, when the output voltage is higher than an upper limit threshold voltage, the control turns on the first low-side switch and the second high-side switch, and turns off the first high-side switch and the second low-side switch.

### CROSS-REFERENCE TO RELATED PATENT APPLICATION

This application claims the benefit of priority to Taiwan Patent Application No. 113149513, filed on Dec. 19, 2024. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a power converter, and more particularly to a power converter having a transient response improvement mechanism.

### BACKGROUND OF THE DISCLOSURE

Power converters are indispensable for electronic devices. The power converters are used to adjust power and supply the adjusted power to the electronic devices. In the power converter, a control circuit must appropriately switch a plurality of switch components such that fast transient response occurs in a current flowing through an inductor for storing power in the inductor and efficiently supplying the appropriate amount of the power from the inductor to a load.

However, in practice, when the control circuit switches the plurality of switch components, the transient response in the current flowing through the inductor is too slow, such that the power converter supplies power to the load at a low efficiency. Alternatively, the power converter supplies excessive power to the load, which results in unnecessary power consumption.

### SUMMARY OF THE DISCLOSURE

In response to the above-referenced technical inadequacies, the present disclosure provides a power converter having a transient response improvement mechanism. The power converter includes a switch circuit and a control circuit. The switch circuit includes a plurality of switch components. Each of the plurality of switch components includes a first high-side switch, a first low-side switch, a second high-side switch and a second low-side switch. A first terminal of the first high-side switch is coupled to an input voltage. A first terminal of the first low-side switch is connected to a second terminal of the first high-side switch. A node between the first terminal of the first low-side switch and the second terminal of the first high-side switch is connected to a first terminal of an inductor. A first terminal of the first low-side switch is connected to a second terminal of the second high-side switch. A second terminal of the second low-side switch is grounded. A node between the first terminal of the first low-side switch and the second terminal of the second high-side switch is connected to a second terminal of the inductor. The control circuit is connected to a control terminal of each of the plurality of switch components and a first terminal of the second high-side switch. The control circuit is configured to switch the switch circuit according to a voltage of the first terminal of the second high-side switch to pull up or down a current of the inductor at a time point being earlier than a predetermined time point.

As described above, the present disclosure provides the power converter having the transient response improvement mechanism. In comparison with conventional power converters, the plurality of high-side switches and the plurality of low-side switches of the power converter of the present disclosure are switched more appropriately to improve transient response in a current of in the inductor. The current of the inductor of the power converter of the present disclosure is able to be pulled up earlier, and is able to be pulled down earlier. Therefore, the power converter of the present disclosure has a better power supply efficiency and supplies a more appropriate amount of power to the load than the conventional power converters.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a circuit diagram of a power converter having a transient response improvement mechanism according to a first embodiment of the present disclosure;

FIG. 2 is a circuit diagram of a power converter having a transient response improvement mechanism according to a second embodiment of the present disclosure;

FIG. 3 is a block diagram of a control circuit of a power converter having a transient response improvement mechanism according to a third embodiment of the present disclosure;

FIG. 4 is a circuit diagram of a control circuit of a power converter having a transient response improvement mechanism according to a fourth embodiment of the present disclosure;

FIG. 5 is a waveform diagram of signals of the power converter having the transient response improvement mechanism according to the first to fourth embodiments of the present disclosure;

FIG. 6 is a waveform diagram of signals of the power converter having the transient response improvement mechanism according to the first to fourth embodiments of the present disclosure; and

FIG. 7 is a waveform diagram of signals of the power converter of the first to fourth embodiments of the present disclosure and a conventional power converter.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

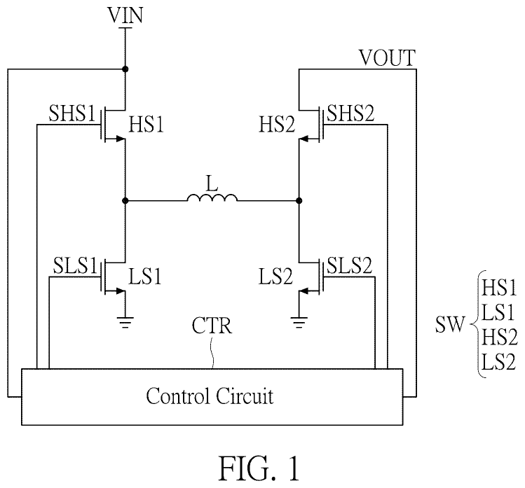

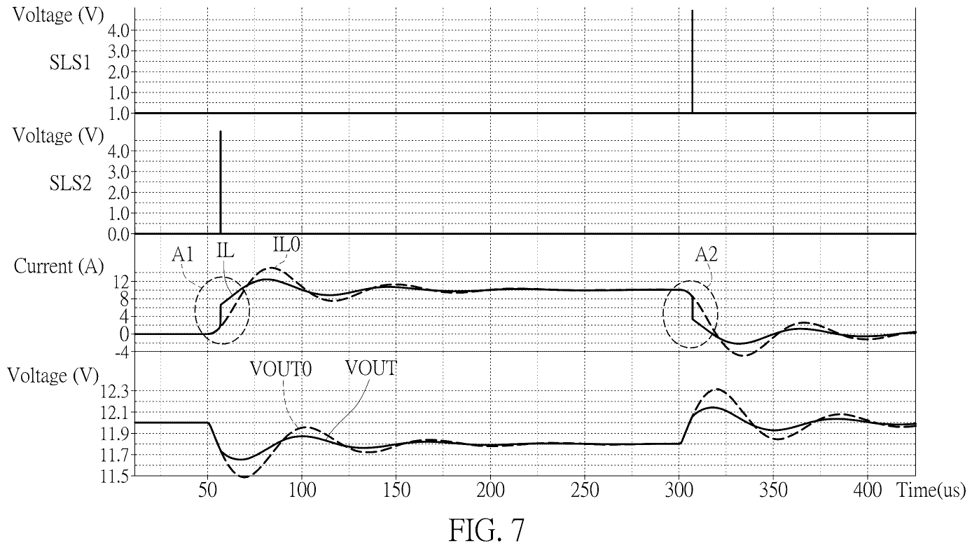

Reference is made to FIG. 1 and FIG. 7, in which FIG. 1 is a circuit diagram of a power converter having a transient response improvement mechanism according to a first embodiment of the present disclosure, and FIG. 7 is a waveform diagram of signals of the power converter of the first to fourth embodiments of the present disclosure and a conventional power converter.

For example, the power converter of the present disclosure may be a buck-boost converter, and may be switched between a plurality of working modes including a pass-through mode. The power converter of the present disclosure performs the following operations, for example, in the pass-through mode.

As shown in FIG. 1, in the first embodiment, the power converter of the present disclosure includes a switch circuit SW and a control circuit CTR. The switch circuit SW includes a plurality of switch components. The plurality of switch components may include a plurality of high-side switches such as a first high-side switch HS1 and a second high-side switch HS2, and a plurality of low-side switches such as a first low-side switch LS1 and a second low-side switch LS2.

The first high-side switch HS1, the first low-side switch LS1, the second high-side switch HS2 and the second low-side switch LS2 may be any type of transistors.

A first terminal of the first high-side switch HS1 is coupled to an input voltage VIN. A first terminal of the first low-side switch LS1 is connected to a second terminal of the first high-side switch HS1. A node between the first terminal of the first low-side switch LS1 and the second terminal of the first high-side switch HS1 is connected to a first terminal of an inductor L.

A first terminal of the second low-side switch LS2 is connected to a second terminal of the second high-side switch HS2. A second terminal of the second low-side switch LS2 is grounded. A node between the first terminal of the second low-side switch LS2 and the second terminal of the second high-side switch HS2 is connected to a second terminal of an inductor L.

A first terminal of the second high-side switch HS2 is used as an output terminal of the power converter of the present disclosure. A voltage of the first terminal of the second high-side switch HS2 is used as an output voltage VOUT of the output terminal of the power converter of the present disclosure.

The control circuit CTR is connected to a control terminal of the first high-side switch HS1, a control terminal of the first low-side switch LS1, a control terminal of the second high-side switch HS2 and a control terminal of the second low-side switch LS2.

The control circuit CTR outputs a plurality of output control signals SHS1, SLS1, SHS2, SLS2 respectively to the control terminal of the first high-side switch HS1, the control terminal of the first low-side switch LS1, the control terminal of the second high-side switch HS2 and the control terminal of the second low-side switch LS2 for controlling the first high-side switch HS1, the first low-side switch LS1, the second high-side switch HS2 and the second low-side switch LS2.

It is worth noting that, the control circuit CTR is connected to the first terminal of the second high-side switch HS2. The control circuit CTR, according to the output voltage VOUT of the first terminal of the second high-side switch HS2, switches the switch circuit SW (including the first high-side switch HS1, the first low-side switch LS1, the second high-side switch HS2 and the second low-side switch LS2) to pull up or down a current of the inductor L at a time point being earlier than a predetermined time point.

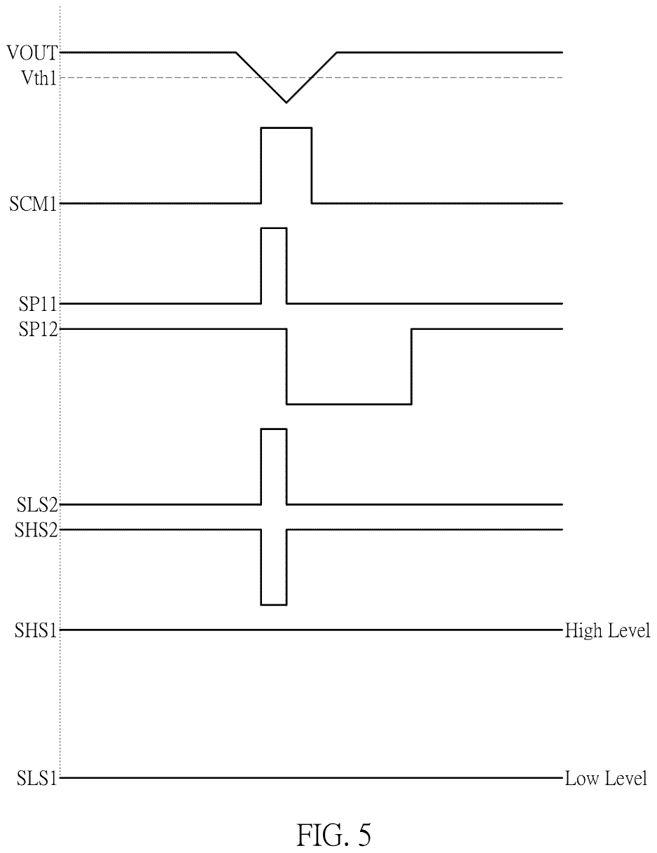

The control circuit CTR may compare the output voltage VOUT of the power converter of the present disclosure with a lower limit threshold voltage Vth1 shown in FIG. 5, and may compare the output voltage VOUT with an upper limit threshold voltage Vth2 shown in FIG. 5. The upper limit threshold voltage Vth2 is higher than the lower limit threshold voltage Vth1. The lower limit threshold voltage Vth1 may be lower than the input voltage VIN, and the upper limit threshold voltage Vth2 may be higher than the input voltage VIN.

For example, when the control circuit CTR determines that the output voltage VOUT of the first terminal of the second high-side switch HS2 is lower than the lower limit threshold voltage Vth1 and lower than the upper limit threshold voltage Vth2, the control circuit CTR turns on the first high-side switch HS1 and the second low-side switch LS2, and turns off the first low-side switch LS1 and the second high-side switch HS2. At this time, the control terminal of the second low-side switch LS2 receives the control signal SLS2 at a high level as shown in FIG. 7 such that the second low-side switch LS2 is turned on.

As a result, as shown in a dotted circle A1 of FIG. 7, a current IL of the inductor L of the power converter of the present disclosure is pulled up earlier than a current IL0 of an inductor of the conventional power converter. Accordingly, a rising transient response in the current IL of the inductor L of the power converter of the present disclosure is faster than that in the current IL0 of the inductor of the conventional power converter.

As shown in FIG. 7, the output voltage VOUT of the power converter of the present disclosure is pulled up faster than that of an output voltage VOUT0 of the conventional power converter. When a load connected to the output terminal of the power converter of the present disclosure transits from a (super) light load to a medium load or a heavy load so as to require more power from the power converter of the present disclosure, the output voltage VOUT of the power converter of the present disclosure is prevented from being reduced to a too low voltage value as the output voltage VOUT0 of the conventional power converter. Therefore, in comparison with the conventional power converter, the power converter of the present disclosure can supply enough power to the load at a higher efficiency.

When the control circuit CTR determines that the output voltage VOUT of the first terminal of the second high-side switch HS2 is higher than the lower limit threshold voltage Vth1 and lower than the upper limit threshold voltage Vth2, the control circuit CTR turns on the first high-side switch HS1 and the second high-side switch HS2, and turns off the first low-side switch LS1 and the second low-side switch LS2.

For example, when the control circuit CTR determines that the output voltage VOUT of the first terminal of the second high-side switch HS2 is higher than the lower limit threshold voltage Vth1 and higher than the upper limit threshold voltage Vth2, the control circuit CTR turns on the first low-side switch LS1 and the second high-side switch HS2, and turns off the first high-side switch HS1 and the second low-side switch LS2. At this time, the control terminal of the first low-side switch LS1 receives the control signal SLS1 at a high level as shown in FIG. 7 such that the first low-side switch LS1 is turned on.

As a result, as shown in a dotted circle A2 of FIG. 7, the current IL of the inductor L of the power converter of the present disclosure is pulled up earlier than the current IL0 of the inductor of the conventional power converter. Accordingly, a falling transient response in the current IL of the inductor L of the power converter of the present disclosure is faster than that in the current IL0 of the inductor of the conventional power converter.

As shown in FIG. 7, the output voltage VOUT of the power converter of the present disclosure is pulled down faster than that of the output voltage VOUT0 of the conventional power converter. Therefore, when the load connected to the output terminal of the power converter of the present disclosure transits from the medium load or the heavy load to the (super) light load so as to require less power from the power converter of the present disclosure, the output voltage VOUT of the power converter of the present disclosure is prevented from being increased to an excessive voltage value as the output voltage VOUT0 of the conventional power converter. Therefore, in comparison with the conventional power converter, the power converter of the present disclosure and the load connected thereto are prevented from being damaged due to overvoltage or overcurrent.

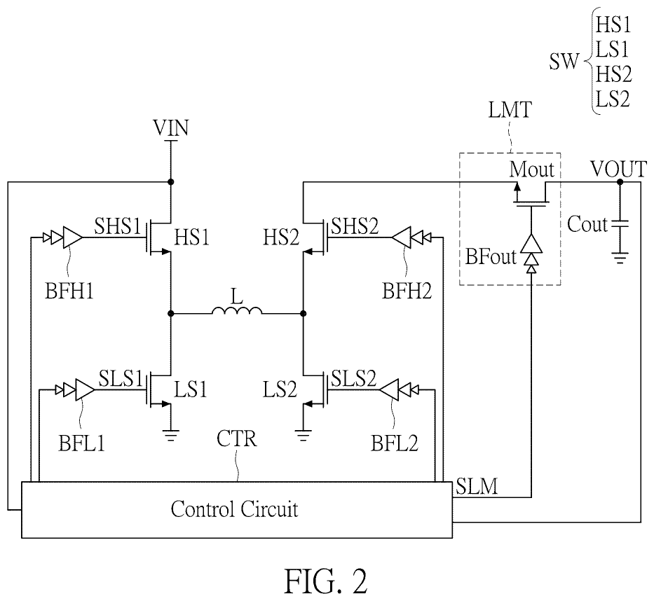

Reference is made to FIG. 2, which is a circuit diagram of a power converter having a transient response improvement mechanism according to a second embodiment of the present disclosure.

The descriptions of the second embodiment of the present disclosure that are the same as the descriptions of the first embodiment of the present disclosure are not repeated herein.

As shown in FIG. 2, in the second embodiment, the power converter of the present disclosure not only includes the first high-side switch HS1, the first low-side switch LS1, the second high-side switch HS2, the second low-side switch LS2 and the control circuit CTR, but also includes an output capacitor Cout, a current limit circuit LMT or a combination thereof.

The current limit circuit LMT may include one or more current limit circuit components such as, but not limited to a transistor Mout. A first terminal of the transistor Mout is connected to the first terminal of the second high-side switch HS2. A second terminal of the transistor Mout is connected to a first terminal of the output capacitor Cout. A second terminal of the output capacitor Cout is grounded.

If necessary, the power converter of the present disclosure may further include one or more buffers such as a first high-side buffer BFH1, a first low-side buffer BFL1, a second high-side buffer BFH2, a second low-side buffer BFL2, a current limit buffer BFout or any combination thereof.

An input terminal of the first high-side buffer BFH1 is connected to a first input terminal of the control circuit CTR. An output terminal of the first high-side buffer BFH1 is connected to the control terminal of the first high-side switch HS1. The first high-side buffer BFH1 may buffer the control signal SHS1 that is outputted from the control circuit CTR to the control terminal of the first high-side switch HS1.

An input terminal of the first low-side buffer BFL1 is connected to a second output terminal of the control circuit CTR. An output terminal of the first low-side buffer BFL1 is connected to the control terminal of the first low-side switch LS1. The first low-side buffer BFL1 may buffer the control signal SLS1 that is outputted from the control circuit CTR to the control terminal of the first low-side switch LS1.

An input terminal of the second high-side buffer BFH2 is connected to a third output terminal of the control circuit CTR. An output terminal of the second high-side buffer BFH2 is connected to the control terminal of the second high-side switch HS2. The second high-side buffer BFH2 may buffer the control signal SHS2 that is outputted from the control circuit CTR to the control terminal of the second high-side switch HS2.

An input terminal of the second low-side buffer BFL2 is connected to a fourth output terminal of the control circuit CTR. An output terminal of the second low-side buffer BFL2 is connected to the control terminal of the second low-side switch LS2. The second low-side buffer BFL2 may buffer the control signal SLS2 that is outputted from the control circuit CTR to the control terminal of the second low-side switch LS2.

An input terminal of the current limit buffer BFout is connected to a fifth output terminal of the control circuit CTR. An output terminal of the current limit buffer BFout is connected to an output terminal of the transistor Mout. The current limit buffer BFout may buffer a control signal SLM that is outputted from the control circuit CTR to the control terminal of the transistor Mout.

A first terminal of the output capacitor Cout may be used as the output terminal of the power converter of the present disclosure.

The current limit circuit LMT is connected between the first terminal of the second high-side switch HS2 and the first terminal of the output capacitor Cout. The current limit circuit LMT may limit an amount of a current that flows from the first terminal of the second high-side switch HS2 to the output terminal of the power converter of the present disclosure, thereby preventing the load from being damaged by an excessive output current from the power converter of the present disclosure.

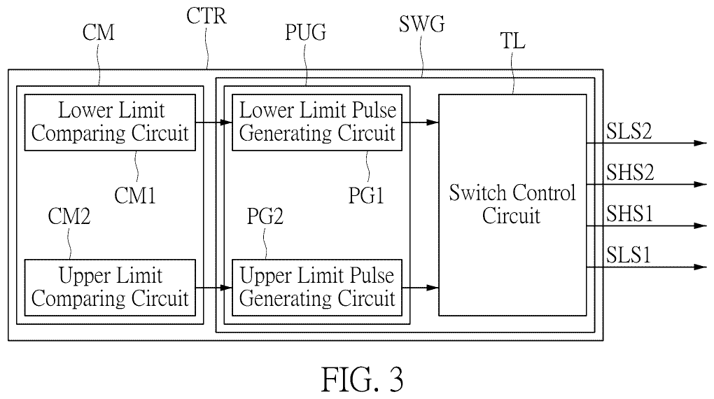

Reference is made to FIG. 3, which is a block diagram of a control circuit of a power converter having a transient response improvement mechanism according to a third embodiment of the present disclosure.

The control circuit CTR shown in FIG. 1 and FIG. 2 may be replaced with the control circuit CTR shown in FIG. 3. As shown in FIG. 3, the control circuit CTR includes a comparing circuit CM and a switching circuit SWG.

The comparing circuit CM includes a lower limit comparing circuit CM1 and an upper limit comparing circuit CM2.

Both of the lower limit comparing circuit CM1 and the upper limit comparing circuit CM2 may be connected to the first terminal of the second high-side switch HS2, the first terminal of the output capacitor Cout, or the second terminal of the transistor Mout. Both of the lower limit comparing circuit CM1 and the upper limit comparing circuit CM2 may obtain the output voltage VOUT of the power converter of the present disclosure from the first terminal of the second high-side switch HS2, the first terminal of the output capacitor Cout, or the second terminal of the transistor Mout.

The lower limit comparing circuit CM1 compares the output voltage VOUT of the power converter of the present disclosure with the lower limit threshold voltage Vth1 and accordingly sets a level of a lower limit comparing signal, and outputs the lower limit comparing signal. The upper limit comparing circuit CM2 compares the output voltage VOUT of the power converter of the present disclosure with the upper limit threshold voltage Vth2 and accordingly sets a level of an upper limit comparing signal, and outputs the upper limit comparing signal.

For example, the switching circuit SWG may include a pulse signal generating circuit PUG and a switch control circuit TL, in which the pulse signal generating circuit PUG may include a lower limit pulse generating circuit PG1 and an upper limit pulse generating circuit PG2.

An input terminal of the lower limit pulse generating circuit PG1 is connected to an output terminal of the lower limit comparing circuit CM1. The lower limit pulse generating circuit PG1 outputs a lower control pulse signal according to the lower limit comparing signal from the lower limit comparing circuit CM1.

An input terminal of the upper limit pulse generating circuit PG2 is connected to an output terminal of the upper limit comparing circuit CM2. The upper limit pulse generating circuit PG2 outputs an upper control pulse signal according to the upper limit comparing signal from the upper limit comparing circuit CM2.

The switching circuit SWG is connected to the output terminal of the lower limit comparing circuit CM1, the output terminal of the upper limit comparing circuit CM2, the control terminal of the first high-side switch HS1, the control terminal of the first low-side switch LS1, the control terminal of the second high-side switch HS2 and the control terminal of the second low-side switch LS2.

The control circuit CTR shown in FIG. 3, according to the lower limit comparing signal and the upper limit comparing signal, outputs the plurality of output control signals SHS1, SLS1, SHS2, SLS2 respectively to the control terminal of the first high-side switch HS1, the control terminal of the first low-side switch LS1, the control terminal of the second high-side switch HS2 and the control terminal of the second low-side switch LS2 for controlling the first high-side switch HS1, the first low-side switch LS1, the second high-side switch HS2, and the second low-side switch LS2 as shown in FIG. 1 or FIG. 2.

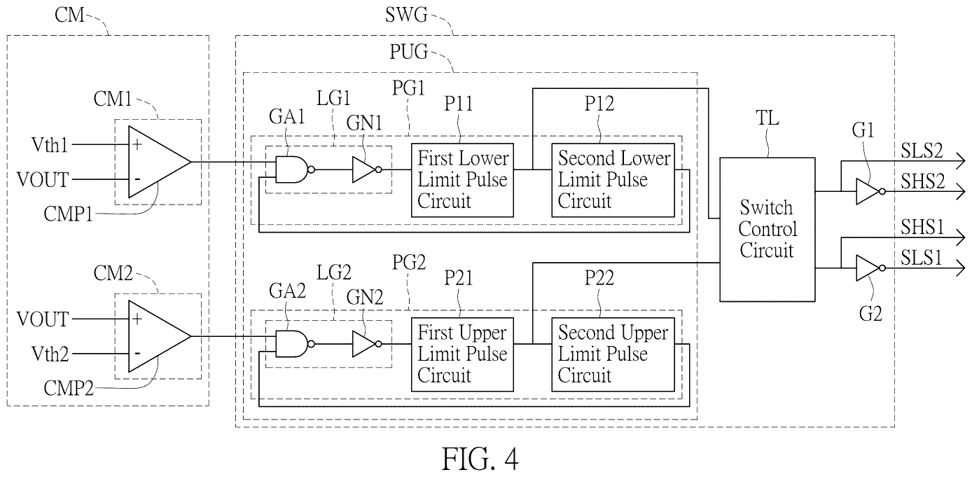

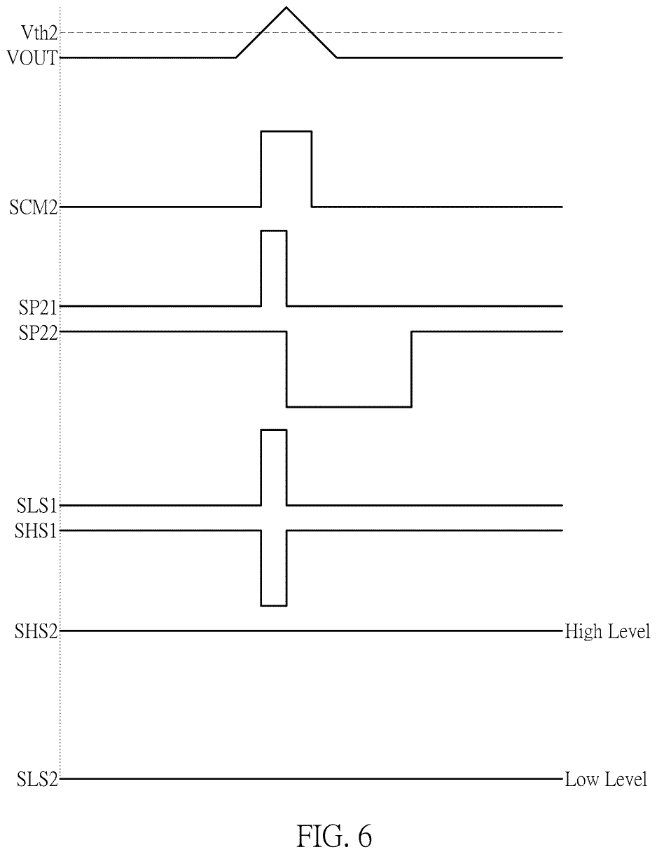

Reference is made to FIG. 4 to FIG. 6, in which FIG. 4 is a circuit diagram of a control circuit of a power converter having a transient response improvement mechanism according to a fourth embodiment of the present disclosure, and FIG. 5 and FIG. 6 are waveform diagrams of signals of the power converter having the transient response improvement mechanism according to the first to fourth embodiments of the present disclosure.

The control circuit CTR shown in FIG. 1 or FIG. 2 may be replaced with the control circuit CTR shown in FIG. 4. The descriptions of the fourth embodiment of the present disclosure that are the same as the descriptions of the third embodiment of the present disclosure are not repeated herein.

Differences between the fourth and third embodiments of the present disclosure are specifically described as follows.

The lower limit comparing circuit CM1 includes a comparator as a lower limit comparator CMP1. As shown in FIG. 4, a first input terminal such as a non-inverting input terminal of the lower limit comparing circuit CM1 is coupled to the lower limit threshold voltage Vth1. A second input terminal such as an inverting input terminal of the lower limit comparing circuit CM1 shown in FIG. 4 is connected to the first terminal of the second high-side switch HS2 shown in FIG. 1 or FIG. 2, the first terminal of the output capacitor Cout shown in FIG. 1 or FIG. 2 or the second terminal of the transistor Mout shown in FIG. 2.

The lower limit comparing circuit CM1 compares the output voltage VOUT from the first terminal of the second high-side switch HS2, the first terminal of the output capacitor Cout or the second terminal of the transistor Mout with the lower limit threshold voltage Vth1 to output the lower limit comparing signal.

The lower limit pulse generating circuit PG1 includes a lower limit logic circuit LG1, a first lower limit pulse circuit P11 and a second lower limit pulse circuit P12. The lower limit logic circuit LG1 may include one or more logic gates such as a first logic gate GA1 (such as a NAND gate) and a second logic gate GN1 (such as a NOT gate) as shown in FIG. 4, or in practice, only includes one gate (such as a AND gate).

As shown in FIG. 4, a first input terminal of the first logic gate GA1 (such as the NAND gate) included in the lower limit logic circuit LG1 is connected to an output terminal of the lower limit comparator CMP1. A second input terminal of the first logic gate GA1 is connected to an output terminal of the second lower limit pulse circuit P12. An input terminal of the second logic gate GN1 (such as the NOT gate) is connected to an output terminal of the first logic gate GA1 (such as the NAND gate). An output terminal of the second logic gate GN1 (such as the NOT gate) is connected to an input terminal of the first lower limit pulse circuit P11.

An output terminal of the first lower limit pulse circuit P11 is connected to an input terminal of the second lower limit pulse circuit P12 and a first input terminal of the switch control circuit TL.

The first logic gate GA1 (such as the NAND gate) of the lower limit logic circuit LG1 outputs an initial lower limit logic signal according to the level of the lower limit comparing signal from the output terminal of the lower limit comparator CMP1 and the level of the lower control pulse signal from the output terminal of the second lower limit pulse circuit P12. The second logic gate GN1 (such as the NOT gate) included in the lower limit logic circuit LG1 outputs the lower limit logic signal according to the initial lower limit logic signal from the first logic gate GA1.

The first lower limit pulse circuit P11 determines whether to generate a pulse wave in the lower control pulse signal according to a level of the lower limit logic signal from the second logic gate GN1 (such as the NOT gate) of the lower limit logic circuit LG1. The first lower limit pulse circuit P11 outputs the lower control pulse signal to the switch control circuit TL.

The switch control circuit TL receives the lower control pulse signal from the first lower limit pulse circuit P11. The switch control circuit TL shown in FIG. 4, according to the lower control pulse signal, sets voltage levels of the plurality of output control signals SHS1, SLS1, SHS2, SLS2 that are outputted respectively to the control terminal of the first high-side switch HS1, the control terminal of the first low-side switch LS1, the control terminal of the second high-side switch HS2 and the control terminal of the second low-side switch LS2 as shown in FIG. 1 or FIG. 2.

If necessary, the control circuit CTR may further include a first NOT gate G1 and a second NOT gate G2. As shown in FIG. 4, in the control circuit CTR, an input terminal of the first NOT gate G1 is connected to a first output terminal of the switch control circuit TL. An input terminal of the first NOT gate G1 is connected to a second output terminal of the switch control circuit TL.

The control terminal of the second low-side switch LS2 shown in FIG. 1 or FIG. 2 may be connected to the first output terminal of the switch control circuit TL included in the control circuit CTR shown in FIG. 4.

The control terminal of the second high-side switch HS2 shown in FIG. 1 or FIG. 2 may be connected to an output terminal of the first NOT gate G1 included in the control circuit CTR shown in FIG. 4.

The control terminal of the first high-side switch HS1 shown in FIG. 1 or FIG. 2 may be connected to the second output terminal of the switch control circuit TL included in the control circuit CTR shown in FIG. 4.

The control terminal of the first low-side switch LS1 shown in FIG. 1 or FIG. 2 may be connected to an output terminal of the second NOT gate G2 included in the control circuit CTR shown in FIG. 4.

As shown in FIG. 5, when the output voltage VOUT of the power converter of the present disclosure is not lower than the lower limit threshold voltage Vth1, the lower limit comparator CMP1 outputs a lower limit comparing signal SCM1 at a first level such as a low level. As a result, the first lower limit pulse circuit P11 outputs a lower control pulse signal SP11 at the first level such as the low level.

It is worth noting that, when the output voltage VOUT of the power converter of the present disclosure is lower than the lower limit threshold voltage Vth1, the lower limit comparator CMP1 outputs the lower limit comparing signal SCM1 at a second level such as a high level. As a result, the first lower limit pulse circuit P11 outputs the lower control pulse signal SP11 that has a pulse wave or at a high level as shown in FIG. 5.

The second lower limit pulse circuit P12 receives the lower control pulse signal SP11 that has the pulse wave or is at the high level from the first lower limit pulse circuit P11. The second lower limit pulse circuit P12, according to the lower control pulse signal SP11 that has the pulse wave or is at the high level, outputs a lower limit shielding pulse signal SP12 at the first level such as the low level, or transits the lower limit shielding pulse signal SP12 from the second level such as the high level to the first level such as the low level. A falling edge of the pulse wave of the lower limit shielding pulse signal SP12 is assigned with a falling edge of the pulse wave of the lower control pulse signal SP11.

The second lower limit pulse circuit P12 sets time during which the lower limit shielding pulse signal SP12 is maintained at the second level such as the low level to be equal to a preset shielding time. The second input terminal of the first logic gate GA1 such as the NAND gate is maintained at a low logic level during the preset shielding time. As a result, the first lower limit pulse circuit P11 outputs the lower control pulse signal SP11 that does not have the pulse wave or is at the low level during the preset shielding time.

Therefore, after the switch control circuit TL switches the switch circuit SW according to the lower control pulse signal SP11 that has the pulse wave or is at high level, the switch control circuit TL temporarily stops switching the switch circuit SW during the preset shielding time according to the lower control pulse signal SP11 from the first lower limit pulse circuit P11. As a result, the power converter of the present disclosure operates stably.

It is worth noting that, as shown in FIG. 5, when the output voltage VOUT of the power converter of the present disclosure is lower than the lower limit threshold voltage Vth1, the control terminal of the second low-side switch LS2 shown in FIG. 1 receives the control signal SLS2 at the second level such as the high level as shown in FIG. 5 from the first output terminal of the switch control circuit TL shown in FIG. 4. At the same time, the control terminal of the second high-side switch HS2 shown in FIG. 1 receives the control signal SHS2 at the first level such as the low level as shown in FIG. 5 from the output terminal of the first NOT gate G1 shown in FIG. 4. At the same time, the control terminal of the first high-side switch HS1 shown in FIG. 1 receives the control signal SHS1 at the second level such as the high level as shown in FIG. 5 from the second output terminal of the switch control circuit TL shown in FIG. 4. At the same time, the control terminal of the first low-side switch LS1 shown in FIG. 1 receives the control signal SLS1 at the first level such as the low level as shown in FIG. 5 from the output terminal of the second NOT gate G2 shown in FIG. 4.

Therefore, when the output voltage VOUT of the power converter of the present disclosure is lower than the lower limit threshold voltage Vth1, the second low-side switch LS2 and the first high-side switch HS1 are turned on, and the first low-side switch LS1 and the second high-side switch HS2 are turned off.

On the other hand, as shown in FIG. 4, the upper limit comparing circuit CM2 includes a comparator as an upper limit comparator CMP2. The first input terminal such as the non-inverting input terminal of the upper limit comparator CMP2 shown in FIG. 4 is connected to the first terminal of the second high-side switch HS2 shown in FIG. 1 or FIG. 2, the first terminal of the output capacitor Cout shown in FIG. 1 or FIG. 2 or the second terminal of the transistor Mout shown in FIG. 2. The second input terminal such as the inverting input terminal of the upper limit comparator CMP2 is coupled to the upper limit threshold voltage Vth2.

The upper limit comparator CMP2 compares the output voltage VOUT from the first terminal of the second high-side switch HS2, the first terminal of the output capacitor Cout or the second terminal of the transistor Mout with the upper limit threshold voltage Vth2 to output the upper limit comparing signal.

The upper limit pulse generating circuit PG2 includes an upper limit logic circuit LG2, a first upper limit pulse circuit P21 and a second upper limit pulse circuit P22. The upper limit logic circuit LG2 may include one or more logic gates such as a first logic gate GA2 (such as a NAND gate) and a second logic gate GN2 (such as a NOT gate), or in practice, only includes one gate (such as a AND gate).

As shown in FIG. 4, the first input terminal of the first logic gate GA2 (such as the NAND gate) included in the upper limit logic circuit LG2 is connected to an output terminal of the upper limit comparator CMP2. A second input terminal of the first logic gate GA2 is connected to an output terminal of the second upper limit pulse circuit P22. An input terminal of the second logic gate GN2 (such as the NOT gate) is connected to an output terminal of the first logic gate GA2 (such as the NAND gate). An output terminal of the second logic gate GN2 (such as the NOT gate) is connected to an input terminal of the first upper limit pulse circuit P21.

An output terminal of the first upper limit pulse circuit P21 is connected to an input terminal of the second upper limit pulse circuit P22 and the first input terminal of the switch control circuit TL.

The first logic gate GA2 (such as the NAND gate) included in the upper limit logic circuit LG2 outputs an initial upper limit logic signal according to a level of the upper limit comparing signal from the output terminal of the upper limit comparator CMP2 and a level of the upper control pulse signal from the output terminal of the second upper limit pulse circuit P22. The second logic gate GN2 (such as the NOT gate) included in the upper limit logic circuit LG2 outputs an upper limit logic signal according to the initial upper limit logic signal from the first logic gate GA2 (such as the NAND gate).

The first upper limit pulse circuit P21 determines whether to generate a pulse wave in the upper control pulse signal according to a level of the upper limit logic signal from the second logic gate GN2 of the upper limit logic circuit LG2. The first upper limit pulse circuit P21 outputs the upper control pulse signal to the switch control circuit TL.

The switch control circuit TL receives the upper control pulse signal from the first upper limit pulse circuit P21. The switch control circuit TL shown in FIG. 4, according to the upper control pulse signal, sets the voltage levels of the plurality of output control signals SHS1, SLS1, SHS2, SLS2 that are outputted respectively to the control terminal of the first high-side switch HS1, the control terminal of the first low-side switch LS1, the control terminal of the second high-side switch HS2 and the control terminal of the second low-side switch LS2 as shown in FIG. 1 or FIG. 2.

As shown in FIG. 6, when the output voltage VOUT of the power converter of the present disclosure is not higher than the upper limit threshold voltage Vth2, the upper limit comparator CMP2 outputs an upper limit comparing signal SCM2 at the first level such as the low level. As a result, the first upper limit pulse circuit P21 outputs an upper control pulse signal SP21 at the first level such as the low level.

It is worth noting that, when the output voltage VOUT of the power converter of the present disclosure is higher than the upper limit threshold voltage Vth2, the upper limit comparator CMP2 outputs the upper limit comparing signal SCM2 at the second level such as the high level. As a result, the first upper limit pulse circuit P21 outputs the upper control pulse signal SP21 that has a pulse wave or is at the high level.

The second upper limit pulse circuit P22, according to the upper control pulse signal SP21 that has the pulse wave or is at the high level as shown in FIG. 6, outputs an upper limit shielding pulse signal SP22 at the first level such as the low level, or transits the upper limit shielding pulse signal SP22 from the second level such as the high level to the first level such as the low level as shown in FIG. 6. A falling edge of the pulse wave of the upper limit shielding pulse signal SP22 is assigned with a falling edge of the pulse wave of the upper control pulse signal SP21.

The second upper limit pulse circuit P22 sets time during which the upper limit shielding pulse signal SP22 is maintained at the second level such as the low level to be equal to the preset shielding time. The second input terminal of the first logic gate GA2 such as the NAND gate is maintained at a low logic level during the preset shielding time. As a result, the first upper limit pulse circuit P21 outputs the upper control pulse signal SP21 that does not have the pulse wave or is at the low level during the preset shielding time.

Therefore, after the switch control circuit TL switches the switch circuit SW according to the upper control pulse signal SP21 that has the pulse wave or is at high level, the switch control circuit TL temporarily stops switching the switch circuit SW during the preset shielding time according to the upper control pulse signal SP21 from the first upper limit pulse circuit P21. As a result, the power converter of the present disclosure can operate stably.

It is worth noting that, as shown in FIG. 5, when the output voltage VOUT of the power converter of the present disclosure is higher than the upper limit threshold voltage Vth2, the control terminal of the first low-side switch LS1 shown in FIG. 1 receives the control signal SLS1 at the second level such as the high level as shown in FIG. 6 from the output terminal of the second NOT gate G2 shown in FIG. 4. At the same time, the control terminal of the first high-side switch HS1 shown in FIG. 1 receives the control signal SHS1 at the first level such as the low level as shown in FIG. 6 from the second output terminal of the switch control circuit TL shown in FIG. 4. At the same time, the control terminal of the second high-side switch HS2 shown in FIG. 1 receives the control signal SHS2 at the second level such as the high level as shown in FIG. 6 from the output terminal of the first NOT gate G1 shown in FIG. 4. At the same time, the control terminal of the second low-side switch LS2 shown in FIG. 1 receives the control signal SLS2 at the first level such as the low level as shown in FIG. 6 from the first output terminal of the switch control circuit TL shown in FIG. 4.

Therefore, when the output voltage VOUT of the power converter of the present disclosure is higher than the upper limit threshold voltage Vth2, the first low-side switch LS1 and the second high-side switch HS2 are turned on, and the first high-side switch HS1 and the second low-side switch LS2 are turned off.

In conclusion, the present disclosure provides the power converter having the transient response improvement mechanism. In comparison with the conventional power converter, the plurality of high-side switches and the plurality of low-side switches of the power converter of the present disclosure are switched more appropriately to improve the transient response in the current of in the inductor. The current of the inductor of the power converter of the present disclosure is able to be pulled up earlier, and is able to be pulled down earlier. Therefore, the power converter of the present disclosure has a better power supply efficiency and supplies a more appropriate amount of power to the load than the conventional power converter.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A power converter having a transient response improvement mechanism,
comprising:
a switch circuit including a plurality of switch components, wherein each of the plurality of switch components includes:
a first high-side switch, wherein a first terminal of the first high-side switch is coupled to an input voltage;
a first low-side switch, wherein a first terminal of the first low-side switch is connected to a second terminal of the first high-side switch, and a node between the first terminal of the first low-side switch and the second terminal of the first high-side switch is connected to a first terminal of an inductor;
a second high-side switch; and
a second low-side switch, wherein a first terminal of the first low-side switch is connected to a second terminal of the second high-side switch, a second terminal of the second low-side switch is grounded, and a node between the first terminal of the first low-side switch and the second terminal of the second high-side switch is connected to a second terminal of the inductor; and
a control circuit connected to a control terminal of each of the plurality of switch components and a first terminal of the second high-side switch, and configured to switch the switch circuit according to a voltage of the first terminal of the second high-side switch to pull up or down a current of the inductor at a time point being earlier than a predetermined time point.

2. The power converter according to claim 1, wherein, when an output voltage of the first terminal of the second high-side switch is lower than a lower limit threshold voltage, the control circuit pulls up the current of the inductor.

3. The power converter according to claim 1, wherein, when an output voltage of the first terminal of the second high-side switch is higher than an upper limit threshold voltage, the control circuit pulls down the current of the inductor.

4. The power converter according to claim 1, wherein, when an output voltage of the first terminal of the second high-side switch is lower than a lower limit threshold voltage and lower than an upper limit threshold voltage, the control circuit turns on the first high-side switch and the second low-side switch and turns off the first low-side switch and the second high-side switch.

5. The power converter according to claim 1, wherein, when an output voltage of the first terminal of the second high-side switch is higher than a lower limit threshold voltage and lower than an upper limit threshold voltage, the control circuit turns on the first high-side switch and the second high-side switch and turns off the first low-side switch and the second low-side switch.

6. The power converter according to claim 1, wherein, when an output voltage of the first terminal of the second high-side switch is higher than a lower limit threshold voltage and higher than an upper limit threshold voltage, the control circuit turns on the first low-side switch and the second high-side switch and turns off the first high-side switch and the second low-side switch.

7. The power converter according to claim 1, wherein the control circuit includes:
a lower limit comparing circuit connected to the first terminal of the second high-side switch, and configured to compare an output voltage of the first terminal of the second high-side switch with a lower limit threshold voltage to output a lower limit comparing signal;
an upper limit comparing circuit connected to the first terminal of the second high-side switch, and configured to compare the output voltage with an upper limit threshold voltage to output an upper limit comparing signal; and
a switching circuit connected to the lower limit comparing circuit, the upper limit comparing circuit and the control terminal of each of the plurality of switch components, and configured to switch the switch circuit according to the upper limit comparing signal and the lower limit comparing signal.

8. The power converter according to claim 7, wherein the switching circuit includes:
a lower limit pulse generating circuit connected to the lower limit comparing circuit, and configured to output a lower control pulse signal according to the lower limit comparing signal;
an upper limit pulse generating circuit connected to the upper limit comparing circuit, and configured to output an upper control pulse signal according to the upper limit comparing signal; and
a switch control circuit connected to the upper limit pulse generating circuit and the lower limit pulse generating circuit, and configured to switch the switch circuit according to the upper control pulse signal and the lower control pulse signal.

9. The power converter according to claim 8, wherein the lower limit pulse generating circuit includes:
a lower limit logic circuit connected to the lower limit comparing circuit, and configured to output a lower limit logic signal according to a level of the lower limit comparing signal and a level of a lower limit shielding pulse signal;
a first lower limit pulse circuit connected to the lower limit logic circuit, and configured to determine whether to generate a pulse wave in the lower control pulse signal according to a level of the lower limit logic signal; and
a second lower limit pulse circuit connected to the first lower limit pulse circuit and the lower limit logic circuit, and configured to determine whether or not the pulse wave is generated in the lower control pulse signal and accordingly set the level of the lower limit shielding pulse signal, and configured to output the lower limit shielding pulse signal.

10. The power converter according to claim 8, wherein the upper limit pulse generating circuit includes:
an upper logic circuit connected to the upper limit comparing circuit, and configured to output an upper logic signal according to a level of the upper limit comparing signal and a level of an upper limit shielding pulse signal;
a first upper limit pulse circuit connected to the upper logic circuit, and configured to determine whether to generate a pulse wave in the upper control pulse signal according to a level of the upper limit logic signal; and
a second upper limit pulse circuit connected to the first upper limit pulse circuit and the upper limit logic circuit, and configured to determine whether or not the pulse wave is generated in the upper control pulse signal and accordingly set the level of the upper limit shielding pulse signal, and configured to output the upper limit shielding pulse signal.

11. The power converter according to claim 1, further comprising:
an output capacitor, wherein a first terminal of the output capacitor is connected to the second terminal of the inductor, and a second terminal of the output capacitor is grounded.

12. The power converter according to claim 1, further comprising:
a current limit circuit connected between the first terminal of the second high-side switch and an output terminal of the power converter, and configured to limit a current that flows from the first terminal of the second high-side switch to the output terminal of the power converter.

13. The power converter according to claim 12, wherein the current limit circuit includes a transistor, a first terminal of the transistor is connected to a first terminal of the second high-side switch, a second terminal of the transistor is connected to an input terminal of the control circuit, and a control terminal of the transistor is connected to an output terminal of the control circuit.
